(19) United States
(12) Patent Application Publication
(10) Pub. No.: US 2015/0042761 A1
(43) Pub. Date: Feb. 12, 2015

(54) METHOD, APPARATUS, AND STEREO CAMERA FOR CONTROLLING IMAGE LIGHTNESS

(71) Applicant: DAEGU GYEONGBUK INSTITUTE OF SCIENCE AND TECHNOLOGY, Dalseong-Goon Daegu (KR)

(72) Inventors: Hyun-Woo Kim, Dalseong-Goon Daegu (KR); Soon Kwon, Dalseong-Goon Daegu (KR); Jangwoo Lee, Dalseong-Goon Daegu (KR); Jaewook Ha, Dalseong-Goon Daegu (KR)

(21) Appl. No.: 14/129,042

(22) PCT Filed: Jul. 12, 2013
(86) PCT No.: PCT/KR2013/006248

§ 371 Date: Mar. 6, 2014

(30) Foreign Application Priority Data
Aug. 30, 2012 (KR) 10-2012-0095537

(51) Int. Cl. H04N 5/243; H04N 5/235; H04N 13/02

(52) U.S. Cl. CPC H04N 5/243; H04N 13/0239; H04N 5/2351
USPC 348/47

(57) ABSTRACT

The present invention relates to a technology of controlling image brightness, and more particularly to an apparatus and a method for controlling brightness of an image, capable of reducing a brightness error between two images photographed by a stereo camera, and the stereo camera for obtaining two images having the brightness error.

### TECHNICAL FIELD

The present invention relates to a technology of controlling brightness of an image.

### BACKGROUND ART

Recently, with development and popularization of a camera module, a camera module has been used in a web cam for a Personal Computer, a camera for security, a black box for a vehicle, and a smartphone, as well as a digital camera. Currently, most cameras which are commercially available have used a single camera module. In a conventional camera, a single camera module has used a method of automatically controlling brightness in order to photograph a subject to be suitable for a dark region and a bright region.

Recently, a stereo camera has been researched and used in various fields such as security, a vehicle, a robot, a three dimensional measurement, and the like.

However, in a structure of a conventional stereo camera, two different cameras may be used, or two cameras may have different initial settings. Two cameras have characteristics different from those of a single camera because they obtain images at different positions. Accordingly, there is a problem in that images acquired by the two cameras respectively may have significantly different brightness.

### DISCLOSURE OF THE INVENTION

### Technical Problems

The present invention has been made to solve the above-mentioned problem in the conventional art, and an aspect of the present invention is to provide an apparatus and a method for controlling brightness of an image, which are capable of reducing an error of brightness between two images captured by stereo cameras.

Another aspect of the present invention is to provide a stereo camera capable of obtaining two images with an error of brightness being reduced.

In accordance with an aspect of the present invention, an apparatus for controlling brightness of an image is provided. The apparatus includes: an image input unit for receiving an input of left and right images captured by a stereo camera; an average brightness value obtaining unit for obtaining an average brightness value for each of the left and right images; and an image brightness control unit for controlling an exposure time of the stereo camera based on a target brightness value and the average brightness value obtained for each of the left and right images, so as to control the image brightness for at least one of the left and right images.

The average brightness value obtaining unit identifies an area in which the left and right images correspond to each other, averages all points in the corresponding area of the left image so as to obtain the average brightness value for the left image, and averages all points in the corresponding area of the right image so as to obtain the average brightness value for the right image.

In accordance with another aspect of the present invention, a method of controlling brightness of an image, which is provided by an apparatus of controlling the brightness of the image, is provided. The method includes: receiving an input of left and right images captured by a stereo camera; obtaining an average brightness value for each of the left and right images; and controlling an exposure time of the stereo camera based on a target brightness value and the average brightness value obtained for each of the left and right images, so as to control the image brightness for at least one of the left and right images.

As described above, according to the present invention, there is an advantage in that the apparatus and the method for controlling the brightness of the image are provided which are capable of reducing a brightness error between two images captured by the stereo camera.

Further, according to the present invention, there is another advantage in that the stereo camera is provided which is capable of obtaining two images having the brightness error reduced.

### BRIEF DESCRIPTION OF THE DRAWINGS

FIG. 1 is a block diagram illustrating an apparatus for controlling brightness of an image according to an embodiment of the present invention;

FIG. 2 is a detailed block diagram illustrating the apparatus for controlling the brightness of the image according to the embodiment of the present invention;

FIG. 3 is a view illustrating a structure of a stereo camera;

FIG. 4 is a view illustrating a process of obtaining a depth image;

FIG. 5 is a view exemplarily illustrating a process of controlling an exposure time;

FIG. 6 is a flowchart illustrating a process of controlling the brightness of the image according to the embodiment of the present invention;

FIG. 7 is a flowchart illustrating a step of obtaining average brightness value in the method of controlling the brightness of the image according to the embodiment of the present invention;

FIG. 8 is a flowchart illustrating a process of controlling the brightness of the image according to the embodiment of the present invention; and

FIG. 9 is a block diagram illustrating the stereo camera according to the embodiment of the present invention.

### MODE FOR CARRYING OUT THE INVENTION

An apparatus for controlling brightness of an image according to an embodiment of the present invention is a device capable of reducing an error of the brightness between left and right images which are captured by a stereo camera.

The apparatus for controlling the brightness of the image according to the embodiment of the present invention controls an increasing or a decreasing of an exposure time necessary for photographing each of the left and right images, so as to reduce the error of the brightness in the left and right images.

Further, in order to reduce the error of the brightness in the left and right images, the apparatus for controlling the brightness of the image according to the embodiment of the present invention has to decide whether the exposure times are made to be long or short to photograph the left and right images respectively, and in some cases, may decide how long time the exposure times are to photograph the left and right images respectively.

As described above, in order to decide a controlling extent of the exposure time, e.g., an increase (+), a decrease (−), a controlled amount, and the like, the apparatus for controlling the brightness of the image according to the embodiment of the present invention has to know how bright the currently captured left and right images are in comparison with reference brightness information (a target brightness value).

Accordingly, the apparatus for controlling the brightness of the image according to the present invention obtains brightness levels of the currently captured left and right images as “an average brightness value for the left image” and “an average brightness value for the right image” respectively. Then, the average brightness value for the left image and the average brightness value for the right image are compared with the target brightness value. If at least one of the average brightness value for the left image and the average brightness value for the right image is not within a range of a permissible error and the target brightness value, the increase or decrease, or an increment or a decrement of the exposure time, which have an effect on the brightness of the image when at least one of the left image and the right image are captured, is controlled so that the at least one of the average brightness value for the left image and the average brightness value for the right image is within the range of the target brightness value and the permissible error, resulting in a reduction of the brightness error between the left image and the right image.

Hereinafter, the apparatus for controlling the brightness of the image and the method of controlling the brightness of the image, which is provided by the image brightness controlling apparatus, according to the embodiment of the present invention will be described in more detail with reference to the accompanying drawings. With an addition of reference numerals to structural elements in the drawings, it is noted that an identical reference numeral possibly indicates an identical structural element although the structural element is shown in different drawings. In the following description of the present invention, a detailed description of known functions or configurations incorporated herein will be omitted when it may make the subject matter of the present invention rather unclear.

In the description of the structural elements of the present invention, terms “first”, “second”, “A”, “B”, “(a)”, “(b)” and the like may be used. The terms are used only to distinguish one structural element from another structural element, and do not limit a true nature, a sequence or an order of the corresponding structural element. In the case that it is described that a certain structural element “is connected to”, “is coupled with”, or “is in contact with” another structural element, it should be interpreted that another structural element may “be connected to”, “be coupled with”, or “be in contact with” other structural elements as well as that the certain structural element is directly connected to or is in direct contact with another structural element.

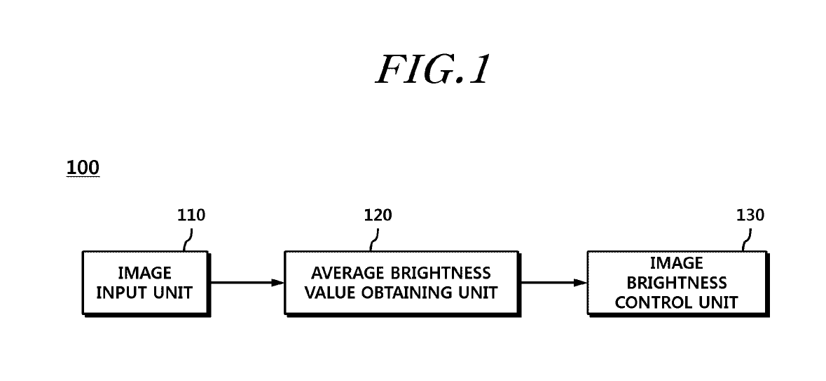

FIG. 1 is a block diagram illustrating the apparatus 100 for controlling the brightness of the image according to the embodiment of the present invention.

Referring to FIG. 1, the apparatus 100 for controlling the brightness of the image according to the embodiment of the present invention includes an image input unit 110 for receiving left and right images captured by the stereo camera, an average brightness value obtaining unit 120 for obtaining an average brightness value for each of the left and right images, and an image brightness controller 130 for controlling an exposure time of the stereo camera based on the obtained average brightness value for each of the left and right images, so as to control the brightness of the image for at least one of the left and right images.

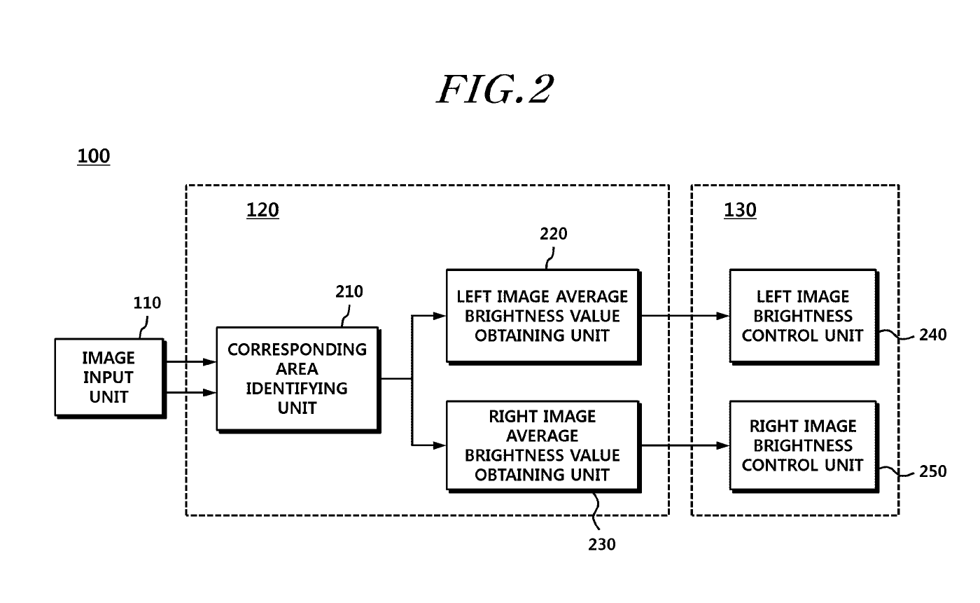

The average brightness value obtaining unit 120 and the image brightness controlling unit 130 in the apparatus 100 for controlling the brightness of the image according to the embodiment of the present invention will be described in more detail with reference to FIG. 2 which is a detailed block diagram of the image brightness controlling apparatus 100.

Referring to FIG. 2, in obtaining brightness information for each of the left and right images, the average brightness value obtaining unit 120 does not obtain the brightness information in entire areas of the left and right images, but may obtain an average brightness (brightness information) in an area of the left image corresponding to the right image and an average brightness (brightness information) in an area of the right image corresponding to the left image.

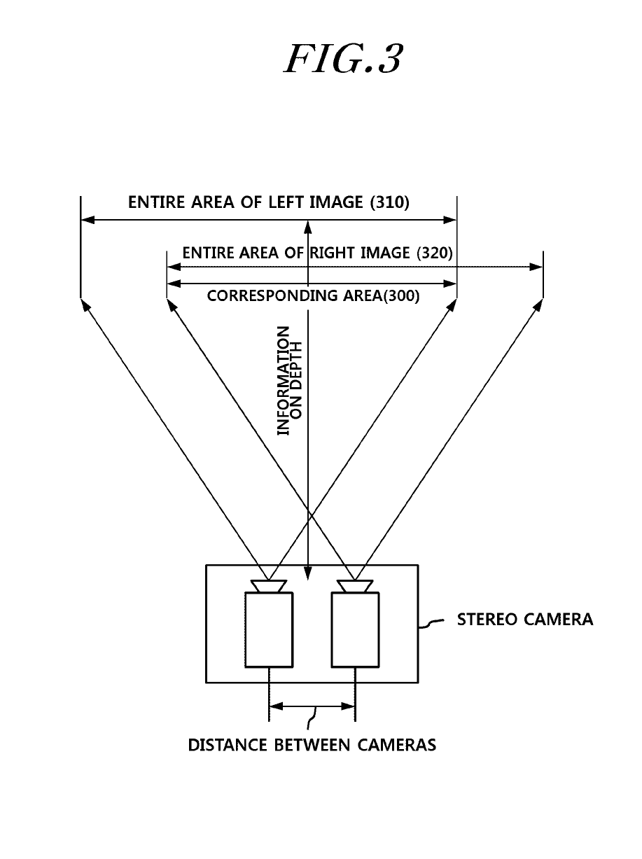

Referring to FIG. 3 showing a schematic structure of the stereo camera, in other words, the average brightness value obtaining unit 120 does not obtain the brightness information in the entire areas 310 and 320 of the left and right images, but obtains the brightness information in the corresponding areas 300 of the left and right images, considering a mutual relation of the left and right images.

To do this, the average brightness obtaining unit 120 may include a corresponding area identifying unit 210 for identifying the corresponding area 300 of the left and right images, a left-image average brightness obtaining unit 220 for obtaining brightness values of points in the area 300 of the left image corresponding to an area of the right image and averaging the obtained brightness values, so as to obtain the average brightness value for the left image, and a right-image average brightness obtaining unit 230 for obtaining brightness values of points in the area 300 of the right image corresponding to the area of the left image and averaging the average brightness value, so as to obtain the average brightness value for the right image.

The corresponding area identifying unit 210 may identify the area in which the left and right images correspond to each other in a step of performing a stereo matching process which is associated with a step of obtaining a depth image.

Here, a phrase “stereo matching” means that an area in which the left and right images are identical, i.e., an area in which the left and right images correspond to each other, is found in order to calculate a value of a parallax in a stereo camera. This method calculates similarity between the corresponding areas of the left and right images to be compared, and it is determined that a point with the highest calculated similarity is an area in which the matching is established. However, in the method, when discrimination for the areas of the left and right images to be compared is decreased, it is possible that an error occurs in which the areas which do not actually correspond to each other may be selected. Therefore, in the present invention, the similarity between candidates for the corresponding areas in the left and right images is obtained, and then a threshold is applied to the similarity, so as to select and use only the corresponding area with high reliability of the matching. That is, only the brightness value with the high reliability is extracted from the corresponding area, so as to obtain the average brightness value.

If a point is present at which an error occurs in the corresponding area obtained through the stereo matching, the corresponding area identifying unit 210 regards the point as a low reliability point, and excludes the point from the area in which the brightness value is obtained.

The corresponding area identifying unit 210 obtains information on differences between the left and right images by moving a coordinate of any one image (left image or right image) by reference of a remaining one (left image or right image) of the left and right images, calculates the similarity between the left and right images based on the obtained difference information, and identifies an area including points where the calculated similarity is larger than a threshold, as the area in which the left and right images correspond to each other.

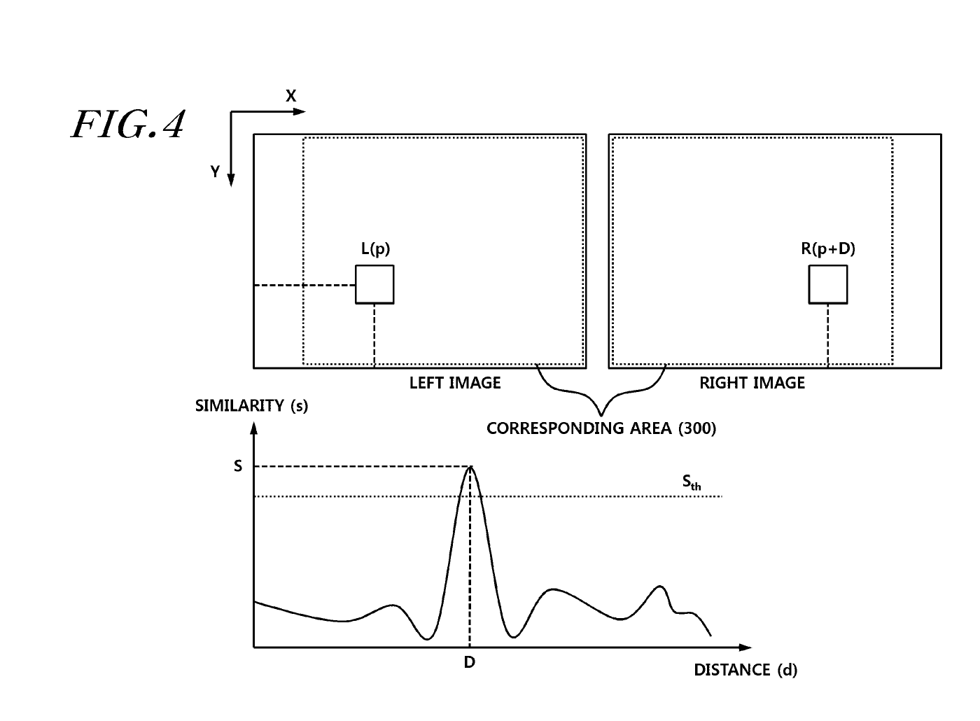

A process of identifying the area where the left and right images correspond to each other will be described as an example with reference to FIG. 4 in which a process of obtaining a depth image is illustrated. The corresponding area identifying unit 210 changes a point, i.e., a pixel p+d (d: a distance between a point in the left image and a point in the right image), in the right image by moving a coordinate of the right image by reference of any one point, i.e., pixel p, in the left image, obtains information on a difference between a pixel value L(p) of any one point in the left image and a second pixel value R(p+d) changed in the right image for the changed point (pixel p+d) in the right image, calculates the similarity s between the point in the left image and the point in the right image, based on the obtained information, and synthetically calculates the similarity information between the point in the left image and the point in the right image according to a change of the distance d between the point in the left image and the point in the right image, i.e., the change of the point in the right image. A graph illustrating the information on the similarity of plural points in the right image, in which the coordinate is changed, for a point in one left image can be identified in FIG. 4.

Referring to FIG. 4, the corresponding area identifying unit 210 performs the process of calculating the similarity information as described above, for all points in the left image. If points in the right image, at which the similarity s may be calculated to be larger than a threshold Sth, among all points in the left image are present, an area including all points in the right image (or points in the left image corresponding to the point in the right image) may be identified as the corresponding area.

The brightness value of each point in the previously identified corresponding area for each of the left and right images is calculated by using following Equation (1).

$$\begin{matrix}{S}_{i} = L ( x , y ) \\ {S}_{j} = R ( x + d , y ) , \\ if {S}_{v} \geq {S}_{th} & ( 1 ) \\ {S}_{avg 1} = \frac{1}{n} {\sum }_{i = 1}^{n} {S}_{i} , \\ {S}_{avg 2} = \frac{1}{n} {\sum }_{j = 1}^{n} {S}_{j} , & ( 2 )\end{matrix}$$

In Equations (1) and (2), Sᵢ is a brightness value of a position, i.e., a point of the left image where similarity is larger than the threshold, in the left image which has reliable similarity, Sⱼ is a brightness value of a position, i.e., a point of the left image where similarity is larger than the threshold, in the right image which has reliable similarity, L(x, y) is a pixel value of the left image, R(x+d, y) is a pixel value of the right image, Sᵥ is the similarity, Sₜₕ is the threshold, and n is the number of positions, i.e., a point of the left image where similarity is larger than the threshold, which have reliable similarity in the left and right images. Further, S_{avg1} is an average brightness value of reliable similarity brightness in the left image, and S_{avg2} is an average brightness value of reliable similarity brightness in the right image.

Referring to FIG. 2, the above-mentioned image brightness controlling unit 130 may include a left image brightness controlling unit 240 for comparing the obtained average brightness value for the left image with the target brightness value, and controlling an increasing and decreasing of an exposure time related to a photographing of the left image in the stereo camera so that an average brightness value is obtained for the left image in order for a difference value between the target brightness value and the average brightness value obtained for the left image to be within a range of a permissible error if the difference value is out of the range of the permissible error, and a right image brightness controlling unit 250 for comparing the obtained average brightness value for the right image with the target brightness value, and controlling an increasing and decreasing of an exposure time related to a photographing of the right image in the stereo camera so that the average brightness value is obtained for the right image in order for a difference value between the target brightness value and the average brightness value obtained for the right image to be within a range of a permissible error if the difference value is out of the range of the permissible error.

The left image brightness controlling unit 240 may decrease the exposure time related to the photographing of the left image in the stereo camera if the difference value between the target brightness value and the average brightness value obtained for the left image is smaller than a lowest value −k in the range, i.e., larger than −k and less than k, of the permissible error, and increase the exposure time related to the photographing of the left image in the stereo camera if the difference value between the target brightness value and the average brightness value obtained for the left image is larger than a highest value +k in the range, i.e., larger than −k and less than k, of the permissible error.

The right image brightness controlling unit 250 may decrease the exposure time related to the photographing of the right image in the stereo camera if the difference value between the target brightness value and the average brightness value obtained for the right image is smaller than a lowest value −k in the range, i.e., larger than −k and less than k, of the permissible error, and increase the exposure time related to the photographing of the right image in the stereo camera if the difference value between the target brightness value and the average brightness value obtained for the right image is larger than a highest value +k in the range, i.e., larger than −k and less than k, of the permissible error.

In the description, the phrase “target brightness value” may be a value set based on a default setting value, the average brightness value obtained for the left image and the average brightness value obtained for the right image, a user setting value, or information on brightness surrounding the stereo camera sensed by a brightness detecting sensor.

Further, the phrase “target brightness value” may be one of the average brightness value obtained for the left image and the average brightness value obtained for the right image.

In this case, it is preferable to control the exposure time related to the photographing of any one of the left and right images. Therefore, the image brightness control unit 130 may include only the left image brightness control unit 240 except for the right image brightness control unit 250.

Meanwhile, the range of the permissible error described above is reference information for determining whether the difference value between the target brightness value and the average brightness value is a permissible error. If the difference value between the target brightness value and the average brightness value (measured value) is in the range of the permissible error, it is unnecessary to control the brightness of the image for the corresponding image. If the difference between the target brightness value and the average brightness value (measured value) is out of the range of the permissible error, it is necessary to control the brightness of the image for the corresponding image.

The range of the permissible error may be set in consideration of various factors in actual circumstances such as probability of occurrence of an error in the obtained average brightness value for each image.

The range of the permissible error may be expressed by a range larger than −k (lowest value) and less than +k (highest value).

As a special example, where k=0, the range of the permissible error may be a constant 0 (zero). This is regarded as an ideal condition in which the image brightness control is not performed only in the case where the difference value between the target brightness value and the obtained average brightness value is 0 (zero), and may be set in the case where the brightness for the left image and the brightness for the right image are completely and identically adapted to the target brightness.

Moreover, the image brightness control unit 130 may differently control the increase or the decrease of the exposure time related to the photographing of the left image in the stereo camera, according to a magnitude of the difference value (T_{avg}−S_{avg1}) between the target brightness value (T_{avg}) and the obtained average brightness value (S_{avg1}) for the left image.

Furthermore, the image brightness control unit 130 may differently control the increase or the decrease of the exposure time related to the photographing of the right image in the stereo camera, according to a magnitude of the difference value (T_{avg}−S_{avg2}) between the target brightness value (T_{avg}) and the obtained average brightness value (S_{avg2}) for the right image.

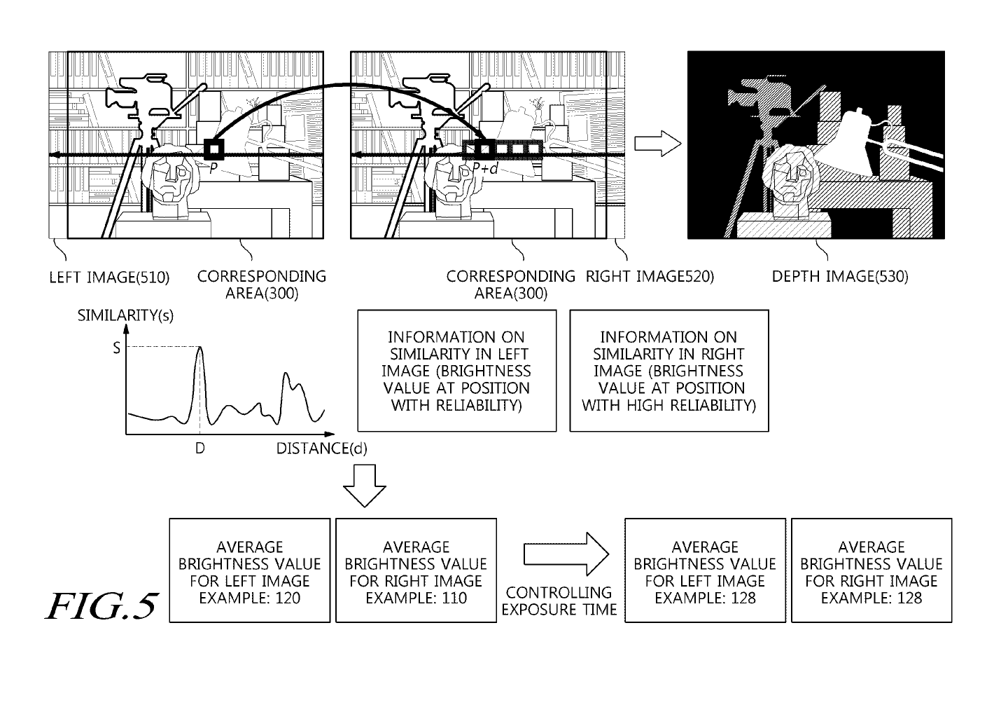

The method in which the image brightness controlling apparatus 100 according to the embodiment of the present invention controls the brightness of the image through the control of the exposure time will be described again with reference to FIG. 5 illustrating a process of controlling the exposure time.

However, the example of FIG. 5 corresponds to a case that the range of the permissible error is 0 (zero) as a special example. That is, only in the case that the brightness of the left image 510 and the brightness of the right image 520 are identical, the example of FIG. 5 may be applied, while if not, the brightness has to be controlled.

Referring to FIG. 5, when the left image 510 and the right image 520 are captured by the stereo camera, the image brightness control apparatus 100 identifies a point (position) where the similarity of the left image 510 and the right image 520 which are captured is larger than the threshold and has high reliability through a process of obtaining the depth image from the left image 510 and the right image 520, so as to identify the corresponding areas 300 of the left image 510 and the right image 520, averages the brightness values of all points in the area of the left image 510 corresponding to the right image 520 so as to obtain an average brightness value for the left image 510, and averages the brightness values of all points in the area of the right image 520 corresponding to the left image 510 so as to obtain an average brightness value for the right image 520.

Therefore, in the case that the average brightness value for the left image 510 is 120 and the average brightness value for the right image 520 is 110, if the target brightness value is 128, a difference value (8=128-120) between the target brightness value and the average brightness value 510 for the left image 510 is larger than 0 (the range of the permissible error in the case where k=0). Accordingly, the exposure time related to the photographing of the left image 510 is prolonged by the obtained difference (8) in comparison with the currently set exposure time so that the average brightness value for the left image 510 becomes the target bright value, that is, the average brightness value for the left image 510 is within the range of the permissible error.

Further, since the difference value (18=128−110) is larger than 0 (the range of the permissible error in the case that k=0), the exposure time related to the photographing of the right image 520 is prolonged by the obtained difference (18) in comparison with the currently set exposure time so that the average brightness value becomes the target brightness value, that is, the average brightness value for the right image 520 is within the range of the permissible error.

At this time, because the difference value between the target brightness value and the obtained average brightness value is larger in the right image 520 than in the left image 510, the right image 520 is made to be bright rather than the left image 510, so that the left image 510 and the right image 520 have the same brightness. That is, in order that the left image 510 and the right image 520 have the same brightness, it is controlled that an increment of the exposure time related to the photographing of the right image 520 is larger than an increment of the exposure time related to the photographing of the left image 510.

Up to now, the image brightness control apparatus 100 according to the embodiment of the present invention has been described. Hereinafter, the method of controlling the brightness of the image by means of the image brightness control apparatus 100 will be described.

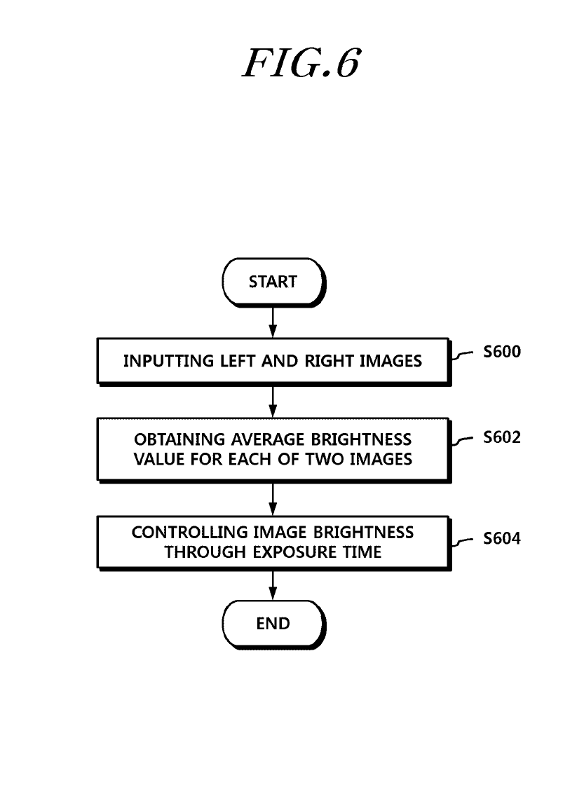

FIG. 6 is a flowchart illustrating a process of controlling the brightness of the image according to the embodiment of the present invention.

Referring to FIG. 6, the method of controlling the brightness of the image by means of the image brightness control apparatus 100 according to the embodiment of the present invention includes receiving an input of the left and right images, which are captured by the stereo camera, by means of the image input unit 110 in step S600, obtaining the average brightness values for the left and right images by means of the average brightness value obtaining unit 120 in step S602, and controlling the exposure time of the stereo camera by means of the image brightness control unit 130, based on the obtained average brightness values for the left and right images in step S604.

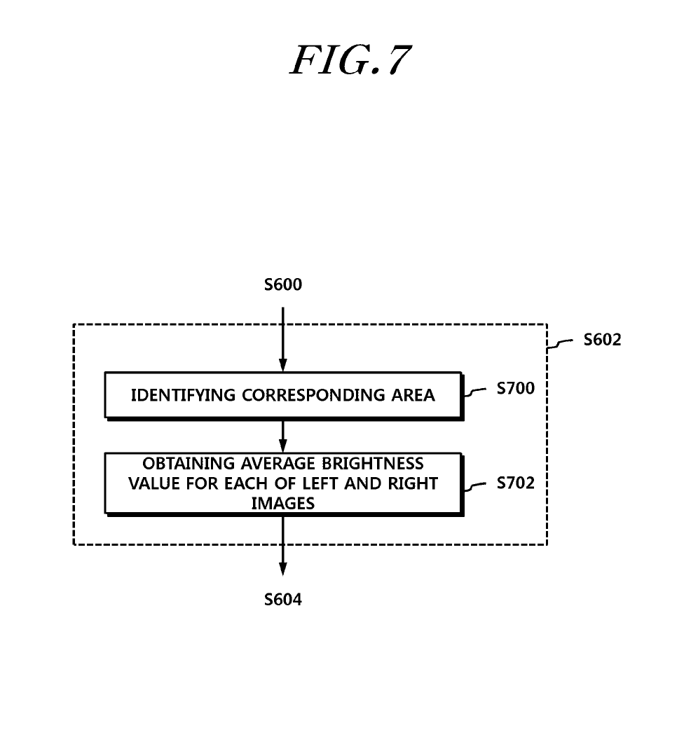

The obtaining of the average brightness value for each of the left and right images in step S602, as shown in FIG. 7, includes identifying an area in which the left and right images correspond to each other, in step S700, and averaging the brightness values of all points in the area of the left image corresponding to the right image, so as to obtain the average brightness value for the left image, while averaging the brightness values of all points in the area of the right image corresponding to the left image, so as to obtain the average brightness value for the right image, in step S702.

In step S700 of identifying the corresponding area, the average brightness value obtaining unit 120 obtains information on the difference between the left and right images by moving coordinates of a remaining image (left image or right image) by reference of any one (left image or right image) of the left and right images, calculates the similarity between the left and right images based on the obtained difference information, and identifies the area including points where the calculated similarity is larger than the threshold, as the corresponding area.

In step S604 of controlling the exposure time, the image brightness controlling unit 130 compares the obtained average brightness value for the left image with the target brightness value, and controls an increasing and decreasing of an exposure time related to a photographing of the left image in the stereo camera so that an average brightness value is obtained for the left image in order for a difference value between the target brightness value and the average brightness value obtained for the left image to be within a range of a permissible error if the difference value is out of the range of the permissible error, compares the obtained average brightness value for the right image with the target brightness value, and controls an increasing and decreasing of an exposure time related to a photographing of the right image in the stereo camera so that the average brightness value is obtained for the right image in order for a difference value between the target brightness value and the average brightness value obtained for the right image to be within a range of a permissible error if the difference value is out of the range of the permissible error.

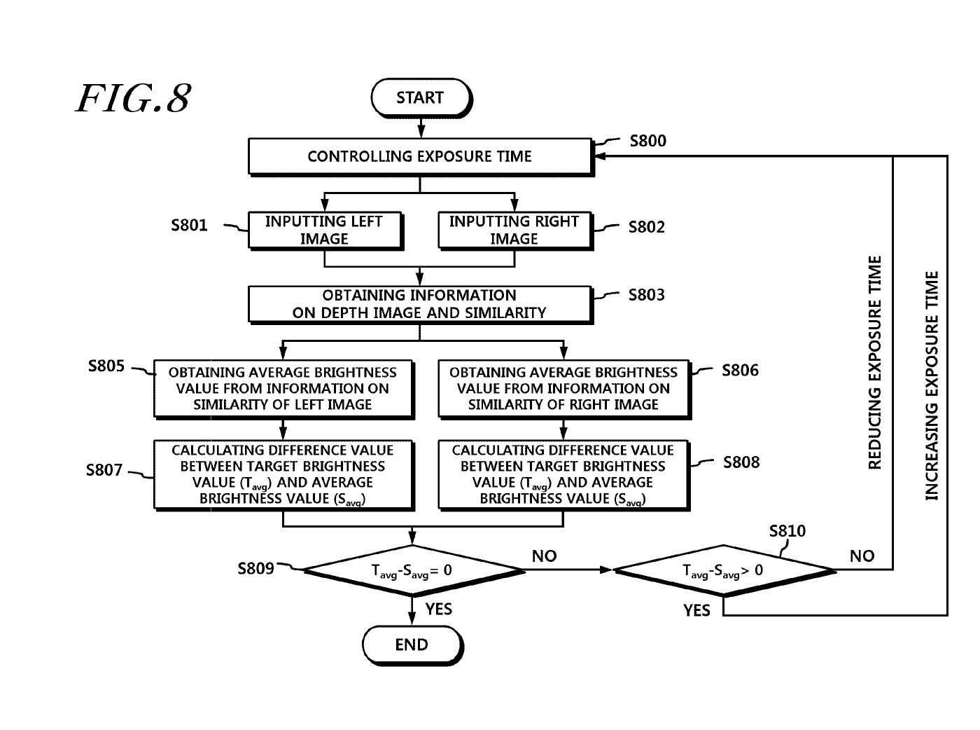

The method of controlling the brightness of the image according to the embodiment of the present invention, described with reference to FIGS. 6 and 7, will be described again with reference to FIG. 8. However, the example of FIG. 8 corresponds to a case that the range of the permissible error is 0 (zero) as a special example. That is, only in the case that the brightness of the left image and the right image are identical, it is allowed that the range of the permissible error is 0 (zero). If not, the exposure time for each of the left and right images is controlled so that the average brightness value of the left image and the average brightness value of the right image are identical to the target brightness value, thereby controlling the brightness of the images.

FIG. 8 is a flowchart illustrating a process of controlling the brightness of the image according to the embodiment of the present invention.

Referring to FIG. 8, the image brightness control apparatus 100 controls the exposure time according to a default value or detected surrounding brightness in step S800, and receives an input of left and right images photographed by the stereo camera according to the controlled exposure time in steps S801 and S802.

Then, the image brightness control apparatus 100 acquires a depth image using the input left and right images, and in the process, as described with reference to FIG. 4, obtains information on a similarity between the left and right images in step S803.

The image brightness control apparatus 100 performs the obtaining of the depth image in step S803, and may identify an area in which the input left and right images correspond to each other, based on the obtained information on the similarity in the process.

Then, the image brightness control apparatus 100 can obtain the average brightness value from the information on the similarity of the left image (i.e., the area of the left image corresponding to the right image) and the average brightness value from the information on the similarity of the right image (i.e., the area of the right image corresponding to the left image) in steps S805 and S806.

Continuously, the image brightness control apparatus 100 calculates a difference value between the target brightness value (T_{avg}) and the average brightness value (S_{avg}) obtained for the left image, and a difference value between the target brightness value (T_{avg}) and the average brightness value (S_{avg}) obtained for the right image in steps S807 and S808.

In turn, the image brightness control apparatus 100 determines whether the difference value between the target brightness value (T_{avg}) and the average brightness value (S_{avg}) obtained for the left image is 0 (zero) in step S809.

As a result of the determination in step S809, if the difference value between the target brightness value (T_{avg}) and the average brightness value (S_{avg}) obtained for the left image is 0 (zero), that is, the target brightness value (T_{avg}) and the average brightness value (S_{avg}) obtained for the left image are identical, the image brightness control apparatus 100 finishes the process of controlling the brightness of the image, and an object is photographed with the stereo camera.

As a result of the determination in step S809, if the difference value between the target brightness value (T_{avg}) and the average brightness value (S_{avg}) obtained for the left image is not 0 (zero), that is, the target brightness value (T_{avg}) and the average brightness value (S_{avg}) obtained for the left image are not identical, the image brightness control apparatus 100 determines whether the difference value between the target brightness value (T_{avg}) and the average brightness value (S_{avg}) obtained for the left image is positive (+), in step S810.

As a result of the determination in step S810, if the difference value between the target brightness value (T_{avg}) and the average brightness value (S_{avg}) obtained for the left image is positive (+), that is, the target brightness value (T_{avg}) is larger than the average brightness value (S_{avg}) obtained for the left image, the left image is dark and the brightness value of the left image is smaller than the target brightness value. Therefore, the image brightness control apparatus 100 controls to increase the exposure time of the left image in step S800.

As a result of the determination in step S810, if the difference value between the target brightness value (T_{avg}) and the average brightness value (S_{avg}) obtained for the left image is negative (−), that is, the target brightness value (T_{avg}) is smaller than the average brightness value (S_{avg}) obtained for the left image, the left image is bright and the brightness value of the left image is larger than the target brightness value. Therefore, the image brightness control apparatus 100 controls to decrease the exposure time of the left image in step S800. Thereby, the brightness of the left image is made to be identical to the brightness to be targeted.

The brightness of the right image is controlled in the same way as the control of the brightness of the left image as follows.

As a result of the determination in step S809, if the difference value between the target brightness value (T_{avg}) and the average brightness value (S_{avg}) obtained for the right image is not 0 (zero), that is, the target brightness value (T_{avg}) and the average brightness value (S_{avg}) obtained for the right image are not identical, the image brightness control apparatus 100 determines whether the difference value between the target brightness value (T_{avg}) and the average brightness value (S_{avg}) obtained for the right image is positive (+), in step S810.

As a result of the determination in step S810, if the difference value between the target brightness value (T_{avg}) and the average brightness value (S_{avg}) obtained for the right image is positive (+), that is, the target brightness value (T_{avg}) is larger than the average brightness value (S_{avg}) obtained for the right image, the right image is dark and the brightness value of the right image is smaller than the target brightness value. Therefore, the image brightness control apparatus 100 controls to increase the exposure time of the right image in step S800.

As a result of the determination in step S810, if the difference value between the target brightness value (T_{avg}) and the average brightness value (S_{avg}) obtained for the right image is negative (−), that is, the target brightness value (T_{avg}) is smaller than the average brightness value (S_{avg}) obtained for the right image, the right image is bright and the brightness value of the left image is larger than the target brightness value. Therefore, the image brightness control apparatus 100 controls to decrease the exposure time of the right image in step S800. Thereby, the brightness of the right image is made to be identical to the brightness to be targeted.

Through the control of the brightness of the left and right images, the brightness of the left and right images is identical, thereby removing or reducing the brightness error.

Up to now, the method of controlling the brightness of the image according to the embodiment of the present invention has been described, which is performed in sequence shown in FIGS. 6, 7 and 8. However, this is merely for convenience of the description. Accordingly, each process may be changed, two or more processes may be integrated, or one process may be divided into two processes, according to an implement scheme, within the scope of the present invention without departing from an essential concept.

As described above, the image brightness control apparatus 100 according to the embodiment of the present invention may be a module which is related to an automatic exposure and included in the stereo camera, or the stereo camera itself.

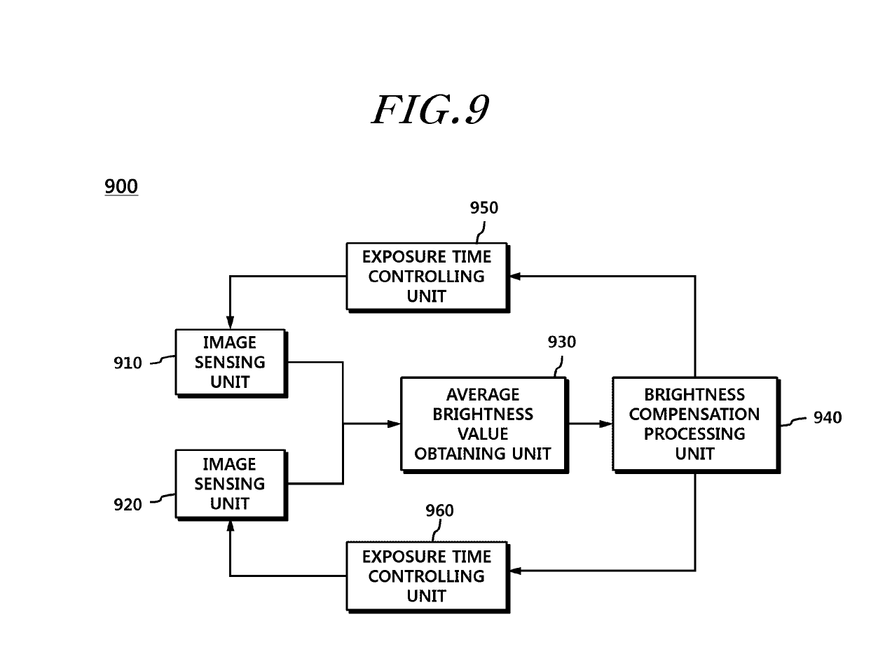

FIG. 9 is a block diagram illustrating the stereo camera 900 according to the embodiment of the present invention.

The stereo camera 900 according to the embodiment of the present invention shown in FIG. 9 includes two image sensing units 910 and 920 for obtaining the left and right images, an average brightness value obtaining unit 930 for obtaining the average brightness value for each of the left and right images obtained by the two image sensing units 910 and 920, a brightness compensation processing unit 940 for identifying information on a brightness compensation for each of the left and right images based on the average brightness value for each of the left and right images, and exposure time control units 950 and 960 for controlling the exposure time related to obtaining each of the left and right images based on the information on the brightness compensation for each of the left and right images.

The average brightness value for each of the left and right images is restrictively obtained not in an entire area of the left image and an entire area of the right image, but in only areas in which the left and right images correspond to each other.

The brightness compensation information for each of the left and right images as described above may include at least one of the difference value between the target brightness value and the average brightness value, information on the increase of the brightness or information on the decrease of the brightness, and information on the increment of the brightness or information on the decrement of the brightness.

As described above, according to the present invention, there is an advantage in that an apparatus and a method for controlling the brightness of the image are provided which are capable of reducing the brightness error between two images captured by stereo cameras.

Further, according to the present invention, there is another advantage in that the stereo camera is provided which is capable of obtaining two images having the brightness error reduced.

Although it is described that all structural elements constituting the embodiment of the present invention are combined and operate as one body, the present invention is not limited to the embodiment. That is, all structural elements may be selectively combined and operate within the scope of the present invention. Further, each of the structural elements may be implemented in the form of an independent hardware, but a part or the entire of the structural elements may be selectively combined and implemented in one or more pieces of hardware as computer programs which have program modules performing functions of a part or the entire of the structural elements. Codes and code segments constituting the computer programs may be inferred by those skilled in the art to which the present invention belongs. The computer programs may be stored in a computer readable media, read and executed by the computer, thereby implementing the embodiment of the present invention. The computer readable media may include a magnetic storage media, an optical storage media and the like.

The terms “include” “consist of” or “has” in the description means that a corresponding structural element may be inherent unless they are not conversely described, and therefore, it should be interpreted that they do not exclude other structural elements, but further include other structural elements. Unless defined differently, all terms used herein, which include technical terminologies or scientific terminologies, have the same meaning as that generally understood by those skilled in the art to which the present invention belongs. It should be interpreted that generally used terminologies such as terms defined in dictionaries have the same meaning as that in context of the related technologies. Furthermore, the terminologies should not be ideally or excessively interpreted in a formal meaning unless they are clearly defined in the present invention.

Although the technical spirit of the present invention has been merely and exemplarily described, it will be understood by those skilled in the art to which the present invention belongs that various changes and modifications may be achieved without departing from the essential characteristic of the present invention. Accordingly, the embodiments disclosed in the present invention are to not limit but merely describe the technical spirit of the present invention. Further, the scope of the technical spirit of the present invention is not limited by the embodiments. The scope of the present invention should be interpreted by claims attached thereto, and it should be interpreted that all technical spirits within the scope equivalent to the claims pertains to the scope of the present invention.

### CROSS-REFERENCE TO RELATED APPLICATION

This application claims the priority under 35 U.S.C. §119(a) to Korean Application Serial No. 10-2012-0095537, which was filed in the Korean Intellectual Property Office on Aug. 30, 2012, the entire content of which is hereby incorporated by reference. In addition, this application claims the priority in all designated nations as well as U.S.A for the same reason as described above, the entire content of which is hereby incorporated by reference.

1-12. (canceled)

13. An apparatus for controlling brightness of an image, the apparatus comprising:
an image input unit for receiving an input of left and right images captured by a stereo camera;
an average brightness value obtaining unit for determining that a point with a maximum similarity is a point where matching is achieved in a stereo matching process for calculating a parallax value of the left and right images, and selecting points where the maximum similarity is larger than a threshold so as to obtain an average value of brightness values for the left and right images at all selected points; and
an image brightness control unit for controlling an exposure time of the stereo camera based on a target brightness value and the average brightness value obtained for each of the left and right images, so as to control the image brightness for at least one of the left and right images.

14. A method of controlling brightness of an image, which is provided by an apparatus for controlling the brightness of the image, the method comprising:
receiving an input of left and right images captured by a stereo camera;
obtaining an average brightness value for each of the left and right images; and
controlling an exposure time of the stereo camera based on a target brightness value and the obtained brightness value for each of the left and right images.

15. The method as claimed in claim 14, wherein the brightness value is an average brightness value of the brightness values of the left and right images at points where a maximum similarity is larger than a threshold in the left image or the right image.

16. The method as claimed in claim 14, wherein the obtaining of the average brightness value comprises:
identifying an area in which the left and right images correspond to each other; and
averaging brightness values of all points in the corresponding area of the left image so as to obtain the average brightness value for the left image, and averaging brightness values of all points in the corresponding area of the right image so as to obtain the average brightness value for the right image.

17. The method as claimed in claim 16, wherein in the identifying of the corresponding area, an area in which the left and right images correspond to each other is identified through a stereo matching.

18. The method as claimed in claim 16, wherein in the identifying of the corresponding area, a similarity is calculated based on information on a difference between the left and right images so as to identify the area in which the left and right images correspond to each other.

19. The method as claimed in claim 16, wherein in the identifying of the corresponding area, a point with a maximum similarity is determined as a point where a matching is achieved in a stereo matching process for calculating a parallax value between the left and right images, and an area including points where the maximum similarity is larger than a threshold is identified as the corresponding area.

20. The method as claimed in claim 14, wherein in the controlling of the image brightness, a target brightness value is compared with the obtained average brightness value for the left image, and an increase and a decrease of the stereo camera related to a photographing of the left image is controlled so that a difference value between the target brightness value and the obtained brightness value for the left image is within a range of a permissible error if the difference value is out of the range of the permissible error, while a target brightness value is compared with the obtained average brightness value for the right image, and an increase and a decrease of the stereo camera related to a photographing of the right image is controlled so that a difference value between the target brightness value and the obtained brightness value for the right image is within a range of a permissible error if the difference value is out of the range of the permissible error.

21. The method as claimed in claim 20, wherein in the controlling of the image brightness, the exposure time of the stereo camera related to the photographing of the left image is increased when the difference value between the target brightness value and the average brightness value obtained for the left image is smaller than a lower limit value in the range of the permissible error, while the exposure time of the stereo camera related to the photographing of the left image is reduced when the difference value between the target brightness value and the average brightness value obtained for the left image is larger than an upper limit value in the range of the permissible error, and the exposure time of the stereo camera related to the photographing of the right image is reduced when the difference value between the target brightness value and the average brightness value obtained for the right image is smaller than a lower limit value in the range of the permissible error, while the exposure time of the stereo camera related to the photographing of the right image is increased when the difference value between the target brightness value and the average brightness value obtained for the right image is larger than an upper limit value in the range of the permissible error.

22. The method as claimed in claim 14, wherein the target brightness value is set based on a default setting value, based on the obtained average brightness value for the left image and the obtained average brightness value for the right image, based on a user setting value, or based on information on detected surrounding brightness.

23. An apparatus for controlling brightness of an image, the apparatus comprising:
an image input unit for receiving an input of left and right images captured by a stereo camera;
a brightness value obtaining unit for obtaining a brightness value for each of the left and right images; and
an image brightness control unit for controlling an exposure time of the stereo camera based on a target brightness value and the obtained brightness value for each of the left and right images.

24. The apparatus as claimed in claim 23, wherein the brightness value is an average brightness value of the brightness values of the left and right images at points where a maximum similarity is larger than a threshold in the left image or the right image.

25. The apparatus as claimed in claim 23, wherein the brightness value obtaining unit comprises:
a corresponding area identifying unit for identifying an area in which the left and right images correspond to each other;
a left image brightness value obtaining unit for obtaining the brightness value for the left image by using brightness values of all points in the corresponding area of the left image; and
a right image brightness value obtaining unit for obtaining the brightness value for the right image by using brightness values of all points in the corresponding area of the right image.

26. The apparatus as claimed in claim 25, wherein the corresponding area identifying unit identifies an area in which the left and right images correspond to each other, through a stereo matching.

27. The apparatus as claimed in claim 25, wherein the corresponding area identifying unit calculates a similarity based on information on a difference between the left and right images so as to identify an area in which the left and right images correspond to each other.

28. The apparatus as claimed in claim 25, wherein the corresponding area identifying unit determines a point with a maximum similarity as a point where matching is achieved, in a stereo matching process of calculating a parallax value between the left and right images, and identifies an area including points where the maximum similarity is larger than a threshold, as the corresponding area.

29. The apparatus as claimed in claim 23, wherein the image brightness control unit comprises at least one of:
a left image brightness control unit compares a target brightness value with the obtained average brightness value for the left image, and controls an increase and a decrease of the stereo camera related to a photographing of the left image so that a difference value between the target brightness value and the obtained brightness value for the left image is within a range of a permissible error if the difference value is out of the range of the permissible error; and
a right image brightness control unit compares a target brightness value with the obtained average brightness value for the right image, and controls an increase and a decrease of the stereo camera related to a photographing of the right image so that a difference value between the target brightness value and the obtained brightness value for the right image is within a range of a permissible error if the difference value is out of the range of the permissible error.

30. The apparatus as claimed in claim 29, wherein the left image brightness control unit reduces the exposure time of the stereo camera related to the photographing of the left image when the difference value between the target brightness value and the obtained brightness value for the left image is smaller than a lower limit value in the range of the permissible error, while increasing the exposure time of the stereo camera related to the photographing of the left image when the difference value between the target brightness value and the obtained brightness value for the left image is larger than an upper limit value in the range of the permissible error, and the right image brightness control unit reduces the exposure time of the stereo camera related to the photographing of the right image when the difference value between the target brightness value and the obtained brightness value for the right image is smaller than a lower limit value in the range of the permissible error, while increasing the exposure time of the stereo camera related to the photographing of the right image when the difference value between the target brightness value and the obtained brightness value for the right image is larger than an upper limit value in the range of the permissible error.

31. The apparatus as claimed in claim 23, wherein the target brightness value is set based on a default setting value, based on the obtained average brightness value for the left image and the obtained average brightness value for the right image, based on a user setting value, or based on information on detected surrounding brightness.
